(19) United States
(12) Patent Application Publication
(10) Pub. No.: US 2016/0147276 A1
(43) Pub. Date: May 26, 2016

(54) RACK SERVER SYSTEM AND POWER MANAGEMENT METHOD THEREOF

(71) Applicants: Inventec (Pudong) Technology Corporation, Shanghai (CN); INVENTEC CORPORATION, Taipei City (TW)

(72) Inventor: Yung-Ying CHEN, Taipei City (TW)

(21) Appl. No.: 14/677,352

(22) Filed: Apr. 2, 2015

(30) Foreign Application Priority Data
Nov. 24, 2014 (CN) 201410680489.1

(51) Int. Cl. G06F 1/32; G06F 1/20

(52) U.S. Cl. CPC G06F 1/3206; G06F 1/20

(57) ABSTRACT

A rack server system and power management method is provided for automatically controlling work state of power supplies. The rack server system includes a plurality of servers, at least one rack management controller, and a power supply module. Each of the servers includes a baseboard management controller, which is configured to monitor a server information of the servers and transmits the server information to the rack management controller. The rack management controller calculates the server information to produce a sever work number so as to transmits a control signal including the sever work number to the power supply module. The power supply units are turned on by the power supply module as receiving the control signal.

### FIELD OF THE INVENTION

The present invention is related to a rack server system, and more particularly related to a rack server system, which can control the number of working power supply units based on a sever work number.

### BACKGROUND OF THE INVENTION

Attending with the progress of technology, network has played an indispensable role in our daily lives, and people are used to do the data communication through the network, such as the communication and interaction by using the social application or social networking websites. For the construction of network, a server is an important apparatus for providing network service. In general, a network system should include a plurality of servers for the purpose of computing a great amount of data.

The above mentioned plurality of servers is usually disposed in a rack as a rack server system to facilitate management, and all the above mentioned servers are electrically connected with a fan and a power supply unit (PSU). With the increasing of server's function, the loading for the servers also increases, and thus it has become an important management issue in present to check if the power supplied by the power supply unit can carry the whole rack server system. The power management method in present usually has the power supply fully turned on to supply power to the servers. However, because not all the servers are working except the rush hour, to fully turn on the power supply may result in the unnecessary power consumption and cause the problem of low conversion efficiency. In addition, to turn on the power supply unit frequently may reduce the life of the power supply unit.

Moreover, because only a portion of the servers are working during the non-rush hour, it is common to only turn on a portion of the power supply units first to supply power to the servers. However, as the rush hour comes, more servers are started and the already turned on power supply units cannot carry the increasing number of working servers and thus the managing persons needs to manually turn on the power supply units. Such operation is quite inconvenient to the managing persons and lacks efficiency. Thus, there exists the need to improve the power management system for the power supply units in present.

### BRIEF SUMMARY OF INVENTION

In view of the rack server system of the conventional art, which has the problem of low power conversion efficiency, short lift time, and poor management because of low management efficiency for the power supply units, a rack server system and a power management method thereof is provided in the present invention, which is capable of controlling the number of power supply units to be turned on based on the number of working severs so as to resolve the problems of the conventional art.

According to the above mentioned object, a rack server system is provided in accordance with an embodiment of the present invention. The rack server system comprises a plurality of server modules, at least a rack management controller, a power supply module, a plurality of fan control boards (FCB), and a plurality of rack fan control boards (RFCB). Each of the server modules has a baseboard management controller (BMC) for monitoring a sever work information to have the plurality of server modules generating and transmitting a plurality of monitoring signals. The rack management controller (RMC) is electrically connected to the baseboard management controllers for receiving the monitoring signals to access the server work information of the server modules so as to calculate a server work number corresponding to the server modules and generate a control signal with a turn-on number M according to the sever work number. The power supply module includes a total of N power supply units and is electrically connected to the rack management controller to turn on M of the N power supply units after receiving the control signal. The fan control boards (FBC) are electrically connected to the baseboard management controllers of the server modules through an intelligent platform management interface (IPMI). The rack fan control boards (RFCB) are electrically connected to the fan control boards through an inter-integrated circuit (I2C) interface, and communicated with the rack management controller through a universal asynchronous receiver/transmitter (UART). Wherein, the server modules transmit the monitoring signals through the fan control boards and the rack fan control boards to the rack management controller, and M is not greater than N.

A power management method is also provided in accordance with an embodiment of the present invention. The power management method is applied to a rack server system, which includes a plurality of server modules, at least a rack management controller, and a power supply module, wherein each of the server modules includes a baseboard management controller, the rack management controller is electrically connected to the server modules, the power supply module is electrically connected to the rack management controller and includes a total of N power supply units. Firstly, the baseboard management controller is used to monitor a sever work information of each of the server modules to have the plurality of server modules generating and transmitting a plurality of monitoring signals. Then, the rack management controller is used to receive the monitoring signals to access the server work information of the server modules so as to calculate a server work number corresponding to the server modules and generate a control signal with a turn-on number M according to the sever work number. Afterward, the control signal is received so as to turn on M of the N power supply units. Wherein M is not greater than N.

In accordance with a preferred embodiment of the rack server system and the power management method thereof provided in present invention, each of the server modules transmits the monitoring signal when the server module is working.

With the feature of detecting the work number of the servers to selectively control the number of power supply units to be turned on, the present invention is capable to startup or turn off the power supply units based on the amount of electric power in need such that the conversion efficiency of the power supply unit can be improved and the life of the power supply unit can be extended.

In addition, because the monitoring signal is transmitted when the server module is working, the number of working power supply units 151 can be added immediately and automatically so as to prevent the loading exceeds the capability of the power supply units such that the difficulty of management can be prevented.

The embodiments adopted in the present invention would be further discussed by using the flowing paragraph and the figures for a better understanding.

### BRIEF DESCRIPTION OF THE DRAWINGS

FIG. 1 is a block diagram showing the rack server system in accordance with a preferred embodiment of the present invention;

FIG. 2 is a block diagram showing the server and the fan control board in accordance with a preferred embodiment of the present invention; and

FIG. 3 is a flow chart showing the power management method in accordance with a preferred embodiment of the present invention.

### DETAILED DESCRIPTION OF THE INVENTION

There are various embodiments of the rack server system provided in accordance with the present invention, which are not repeated hereby. Only a preferred embodiment is mentioned in the following paragraph as an example.

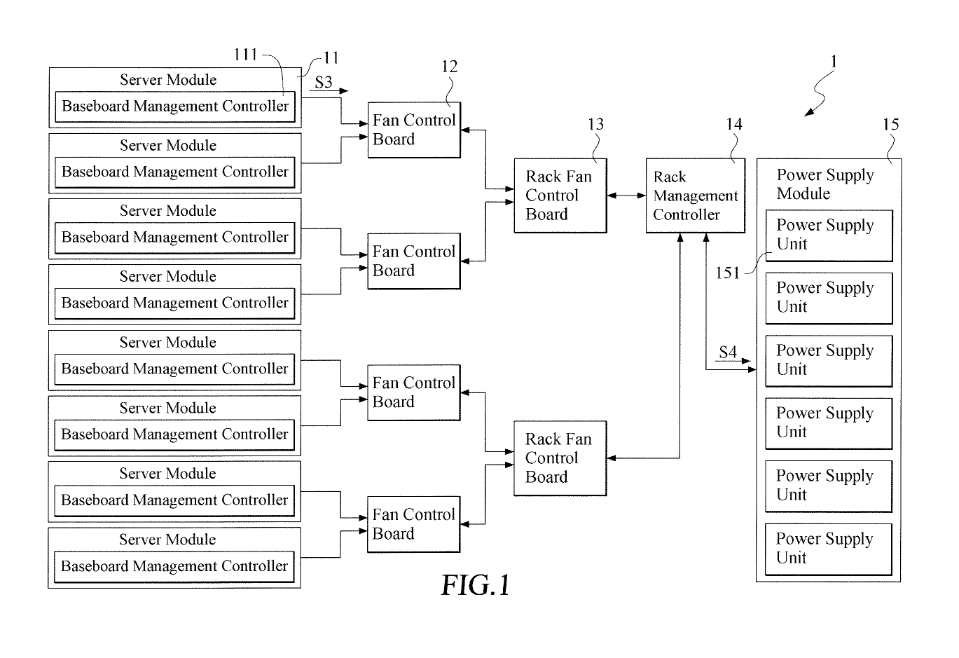

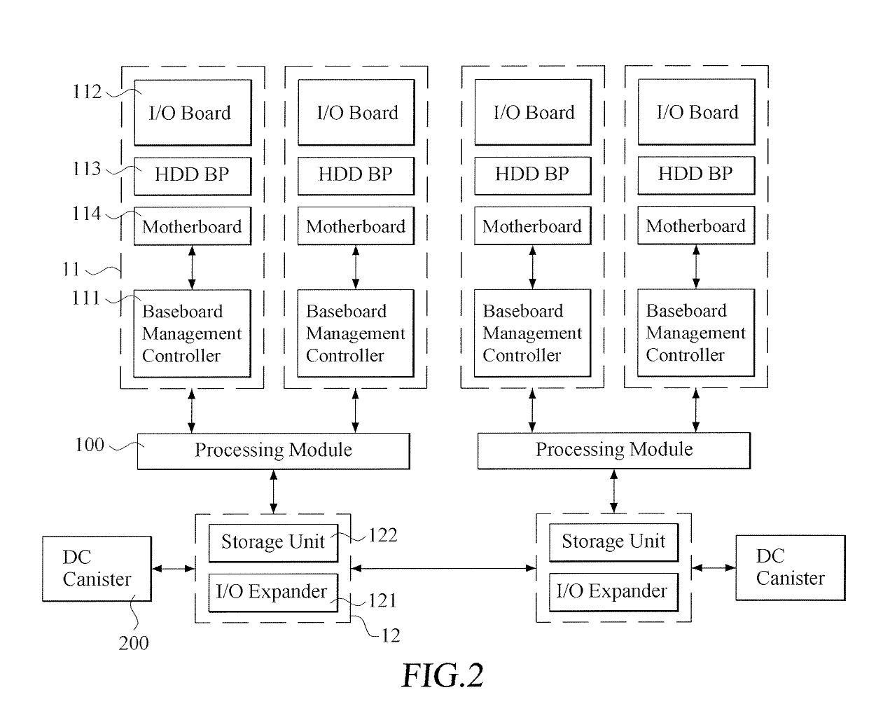

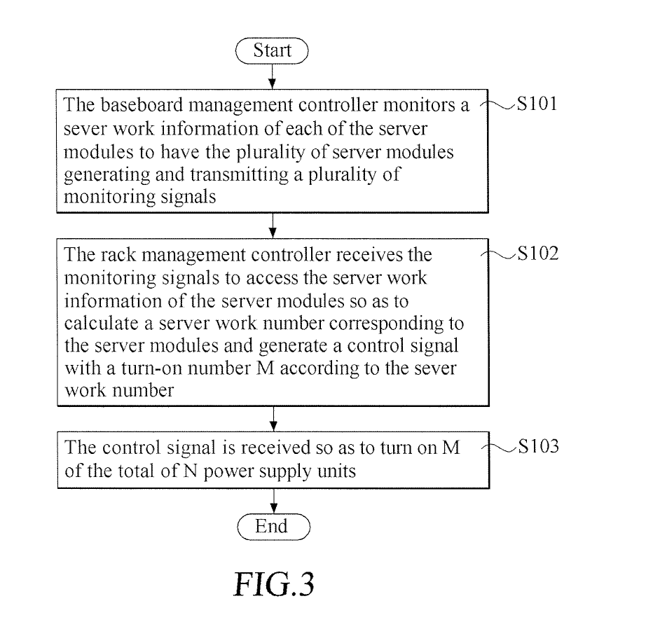

Please refer to FIGS. 1 to 3, wherein FIG. 1 is a block diagram showing the rack server system in accordance with a preferred embodiment of the present invention, FIG. 2 is a block diagram showing the server and the fan control board in accordance with a preferred embodiment of the present invention, and FIG. 3 is a flow chart showing the power management method in accordance with a preferred embodiment of the present invention. As shown, the rack server system 1 includes a plurality of server modules 11 (only one of them is labeled), a plurality of fan control boards (FCB) 12 (only one of them is labeled), a plurality of rack ran control board (RFCB) 13 (only one of them is labeled), at least a rack management controller (RMC) 14 (only one is shown in the present embodiment, but in practice, more RMC can be used), and a plurality of power supply modules 15.

These server modules 11 can be a server, and each of the server modules 11 includes a baseboard management controller (BMC) 111. In addition, as shown in FIG. 2, the server module 11 also includes the device, which can be a hardware, a firmware, or a software, such as an I/O board 112, a hard disc drive back plate (HDD BP) 113, a motherboard 114, a battery and etc. The server module 11 also electrically connected to a processing module 100, such as a processor in a box (PIB). In addition, the processing module 100 can be integrated into the server module 11 or the fan control board 12. Such technology is conventional and thus is not given the unnecessary detail.

These fan control boards 12 are communicated with the baseboard management controller 111 through the processing module 100, and electrically connected with a power conversion module (DC Canister) 200. The power conversion module 200 can be for example a power distribution board (PDB), and can be integrated in the fan control board 12 or the rack fan control board 13. Furthermore, in the present embodiment, the fan control board 12 is communicated with the baseboard management controller 111 through an intelligent platform management interface (IPMI). However, in the other embodiments, the fan control board 12 can be communicated with the baseboard management controller 111 wirelessly. In addition, the fan control board 12 may include the hardware devices, for example a processing module, an I/O expander 121, a storage unit 122 such as a electrically-erasable programmable read-only memory (EEPROM), a sensor, and etc., and communicated with the above mentioned I/O board and the hard disc drive back plate (HDD BP) through a universal asynchronous receiver/transmitter (UART). Such technology is conventional and thus is not given the unnecessary detail.

The rack fan control board 13 is communicated with these fan control boards 12. Concretely speaking, the rack fan control board 13 is communicated with the fan control boards 12 through an inter-integrated circuit (I²C) interface. In addition, the rack fan control board 13 may include a processing module (not shown) such as a micro control unit (MCU). However, the present invention is not so restricted. Any circuit with the function to process data should be deemed as within the scope of the present invention. In addition, the rack fan control board 13 may further include the hardware devices such as an EEPROM, a sensor and etc. Such technology is conventional and thus is not given the unnecessary detail.

The rack management controller 14 is communicated with these rack fan control boards 13. Concretely speaking, the rack management controller 14 is communicated with these rack fan control boards 13 through a universal asynchronous receiver/transmitter (UART). The rack management controller 14 may include the hardware devices such as a processor (such as an MCU), a storage module (e.g. the existed memory), a sensor, and etc. Such technology is conventional and thus is not given the unnecessary detail.

The power supply module 15 includes a total of N power supply units (PSU) 151 and is electrically connected to the rack management controller 14. For example, in the preferred embodiment of the present invention as an example, the number N is 6, but the number N can be 10 in the other embodiments. However, the present invention is not so restricted. It is also noted that the information of the server module 11, such as physical location, identification name, network address, and amount of power consumption, can be stored in the storage module of the rack management controller 14. In addition, the information of the power supply module 15, such as physical location, identification name, network address, and amount of supplied power, can also be stored in the storage module.

In practice, the baseboard management controllers 111 of these server modules 11 can be used to monitor a server work information of each server module 11 to have these server modules 11 generate and transmit a plurality of monitoring signals S3. The server work information may include physical location, identification name, network address, and needed power of each server module 11. That is, the monitoring signals S3 include the above mentioned server work information. In addition, it should be noted that the monitoring signals S3 are transmitted from the server modules 11 through the fan control board 12 and the rack fan control board 13. That is, the monitoring signals S3 are transferred through the fan control board 12 and the rack fan control board 13, and during the transmission of the monitoring signals S3, the processing module of the fan control board 12 and the rack fan control board 13 may execute an operation to the monitoring signals S3, and such operation can be a translation procedure such as coding and decoding so as to have the signal compatible to the communication protocol of each interface. Such signal, i.e. the translated signal, is also defined as the monitoring signal S3 in the preferred embodiment of the present invention.

After the rack management controller 14 receives these monitoring signals S3 to access the server work information of these server modules 11, the rack management controller 14 calculates a server work number corresponding to these server modules 11 and generates a control signal S4 including a turn-on number M corresponding to the server work number. That is, the processing module of the rack management controller 14 can identify which one of the server modules 11 needs to be turned on, has been turned on, or needs to be turned off. Then, a concluded server work number can be calculated. Then, the rack management controller 14 can calculate the number of the power supply modules 15 needs to be turned on based on the concluded server work number. In the preferred embodiment of the present invention, it is assume that there are M power supply modules 15 needed to be turned on such that the control signal S4 with the turn-on number M is generated and transmitted.

After the power supply modules 15 receive the control signal S4, M of the total N power supply units 151 are turned on. That is, M is not greater than N. The number of non working power supply units 151 is defined as P. Furthermore, as shown in the following table, because the number N is 6 or 10 in accordance with the embodiments of the present invention and the number N is the sum of number M and number P, the number N and the number P can be adjusted according the conditions in practice. In addition, the conditions shown in the following table can be stored in the storage module of the rack management controller 14 in advance, i.e. as the preset conditions. However, in the preferred embodiment of the present invention, the adjustment is made in accordance with the actual condition automatically rather than a preset condition.

| | N = 6 | N = 10 |
|---|---|---|
| Condition 1 (M + P) | 3 + 3 | 3 + 7 |
| Condition 2 (M + P) | 4 + 2 | 4 + 6 |
| Condition 3 (M + P) | 5 + 1 | 5 + 5 |
| Condition 4 (M + P) | 6 + 0 | 10 + 0 |

In addition, as shown in the above table, condition 1 can be assumed as there are 21 to 40 server modules at work, condition 2 can be assumed as there are 41 to 60 server modules at work, condition 3 can be assumed as there are 61 to 80 server modules at work, and the other conditions can be defined as condition 4. Such setting can be arranged according to the need in practice. The throttling setting corresponding to the above mentioned working conditions of the server modules 11 can be shown as below:

| | Supplied Power | Reserved Power |
|---|---|---|
| Condition 1 | 6000 | 4800 |
| Condition 2 | 8000 | 6400 |
| Condition 3 | 10000 | 8000 |
| Condition 4 | 10000 | 8000 |

The unit being used in the above table can be the ordinary power supply unit, such as Watt, and the setting is also controlled by the rack management controller 14 to prevent the server modules 11 from consuming additional power when processing a huge amount of data. The supplied power is the sum of power supplied by the M power supply units 151. The reserved power is the total power supplied by the P power supply units 151. In addition, the above mentioned P power supply units 151 can be the power supply units which had been turned off, or the working power supply units 151 with a cutoff electrically connection to the server modules 11 such that the generated electric power cannot be provided to the server modules 11. The typical transistor switches can be used to selectively turned-on or cut off the electric connection.

As a preferred embodiment, each of the server modules 11 may transmit the monitoring signal S3 as the server module 11 is working. Concretely speaking, the meaning of working in the present invention is defined as the duration that the server module 11 has not been started yet but just entered system check during the booting process (such as BIOS setup) during the rush hour. Thus, in accordance with the preferred embodiment of the present invention, the number of working power supply units 151 can be adjusted immediately in response to the sudden change of the server modules 11 so as to prevent the loading exceeds the capability of the original number of the power supply units.

In addition, the electric power provided by the started power supply units 151 can be transmitted to the power conversion module 200 through the rack management controller 14 and the rack fan control board 13. The power conversion module 200 converts the received electric power, for example, the received 380V electric power is converted into the electric power of 12V or 3.5V, and transmits the converted electric power through the processing module 100 to the server module 11.

In addition, please refer to FIG. 3, which is a flow chart showing the power management method in accordance with a preferred embodiment of the present invention. As shown, the power management method in accordance with the preferred embodiment of the present invention comprises the steps of:

Step S101: the baseboard management controller 111 monitors a sever work information of each of the server modules 11 to have the plurality of server modules 11 generating and transmitting a plurality of monitoring signals S3;

Step S102: the rack management controller 14 receives the monitoring signals S3 to access the server work information of the server modules 11 so as to calculate a server work number corresponding to the server modules 11 and generate a control signal S4 with a turn-on number M according to the sever work number; and

Step S103: the power supply module receives the control signal S4 so as to turn on M of the total of N power supply units 151 after receiving the control signal S4.

In conclusion, with the feature of detecting the work number of the servers to selectively control the number of power supply units to be turned on, the present invention is capable to startup or turn off the power supply units based on the amount of electric power in need such that the conversion efficiency of the power supply unit can be improved and the life of the power supply unit can be extended. In addition, because the number of working power supply units can be adjusted immediately and automatically, the difficulty of management can be prevented and thus the efficiency can be enhanced.

The detail description of the aforementioned preferred embodiments is for clarifying the feature and the spirit of the present invention. The present invention should not be limited by any of the exemplary embodiments described herein, but should be defined only in accordance with the following claims and their equivalents. Specifically, those skilled in the art should appreciate that they can readily use the disclosed conception and specific embodiments as a basis for designing or modifying other structures for carrying out the same purposes of the present invention without departing from the scope of the invention as defined by the appended claims.

We claim:

1. A rack server system, comprising:
a plurality of server modules, each of the server modules having a baseboard management controller (BMC) for monitoring a sever work information to have the plurality of server modules generating and transmitting a plurality of monitoring signals;
at least a rack management controller (RMC), electrically connected to the baseboard management controllers, for receiving the monitoring signals to access the server work information of the server modules so as to calculate a server work number corresponding to the server modules and generate a control signal with a turn-on number M according to the sever work number;
a power supply module, which includes a total of N power supply units, electrically connected to the rack management controller to turn on M of the N power supply units after receiving the control signal;
a plurality of fan control boards (FBC), electrically connected to the baseboard management controllers of the server modules through an intelligent platform management interface (IPMI); and
a plurality of rack fan control boards (RFCB), electrically connected to the fan control boards through an inter-integrated circuit (I²C) interface, and communicated with the rack management controller through a universal asynchronous receiver/transmitter (UART);
wherein, the server modules transmit the monitoring signals through the fan control boards and the rack fan control boards to the rack management controller, and M is not greater than N.

2. The rack server system of claim 1, wherein each of the server modules transmits the monitoring signal when the server module is working.

3. A power management method, applied to a rack server system, which includes a plurality of server modules, at least a rack management controller, and a power supply module, wherein each of the server modules includes a baseboard management controller, the rack management controller is electrically connected to the server modules, the power supply module is electrically connected to the rack management controller and includes a total of N power supply units, and the power management method comprising the steps of:
(a) monitoring, by the baseboard management controller, a sever work information of each of the server modules to have the plurality of server modules generating and transmitting a plurality of monitoring signals;
(b) receiving, by the rack management controller, the monitoring signals to access the server work information of the server modules so as to calculate a server work number corresponding to the server modules and generate a control signal with a turn-on number M according to the sever work number; and
(c) receiving the control signal so as to turn on M of the N power supply units;
wherein M is not greater than N.

4. The power management method of claim 3, wherein each of the server modules transmits the monitoring signals when the server module is working.
